(19) United States
(12) Patent Application Publication
(10) Pub. No.: US 2026/0292378 A1
(43) Pub. Date: Sep. 24, 2026

(54) ACOUSTIC SYSTEM AND MOBILE DEVICE COMPRISING THE SAME

(71) Applicant: Intel Corporation, Santa Clara, CA (US)

(72) Inventors: Jay Vishnu GUPTA, Bangalore (IN); Prasanna PICHUMANI, Bangalore (IN); Shruthi SUDHAKAR, Bangalore (IN); Tejasweeni Dhananjay LINGAYAT, Maharashtra (IN); Ezekiel POULOSE, Ernakulam (IN); Sumod CHERUKKATE, Bangalore (IN); Bala SUBRAMANYA, Bangalore (IN); Jayprakash THAKUR, Bangalore (IN)

(21) Appl. No.: 19/086,224

(22) Filed: Mar. 21, 2025

(51) Int. Cl. H04R 1/02

(52) U.S. Cl. CPC H04R 1/02; H04R 2499/15

(57) ABSTRACT

Provided is an acoustic system. The acoustic system includes a speaker assembly including a speaker driver and an enclosure defining a back volume for the speaker driver. The acoustic system additionally includes an antenna assembly disposed adjacent to the speaker assembly. The antenna assembly includes an active region and a ground region. Further, the acoustic system includes a filler material disposed within the back volume and configured to simulate a larger back volume for the speaker driver. The active region of the antenna assembly is disposed opposite a first portion of the back volume. The first portion of the back volume is unoccupied by the filler material.

### BACKGROUND

The integration of system antennas in laptop designs presents a significant challenge due to limited space. Co-locating antennas with speaker boxes can introduce Radio Frequency Interference (RFI), while the conductive properties of certain materials used in speaker boxes may further compromise antenna performance. There may be a demand to overcome the above limitations.

### BRIEF DESCRIPTION OF THE FIGURES

Some examples of apparatuses and/or methods will be described in the following by way of example only, and with reference to the accompanying figures, in which

FIG. 1 schematically illustrates an example of an acoustic system;

FIG. 2 schematically illustrates another example of an acoustic system in an assembly situation;

FIG. 3 schematically illustrates an enclosure of the speaker assembly illustrated in FIG. 2;

FIG. 4 schematically illustrates a first exemplary arrangement of filler material in the enclosure of the speaker assembly illustrated in FIG. 3;

FIG. 5 schematically illustrates a second exemplary arrangement of filler material in the enclosure of the speaker assembly illustrated in FIG. 3;

FIG. 6 illustrates an exemplary comparison of antenna performances;

FIG. 7 schematically illustrates an example of a mobile device comprising an acoustic system;

FIG. 8 illustrates an exemplary comparison of shielding performance in a first frequency range;

FIG. 9 illustrates an exemplary comparison of shielding performance in a second frequency range; and

FIG. 10 illustrates a flowchart of an example of a method of manufacturing an acoustic system.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A or B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

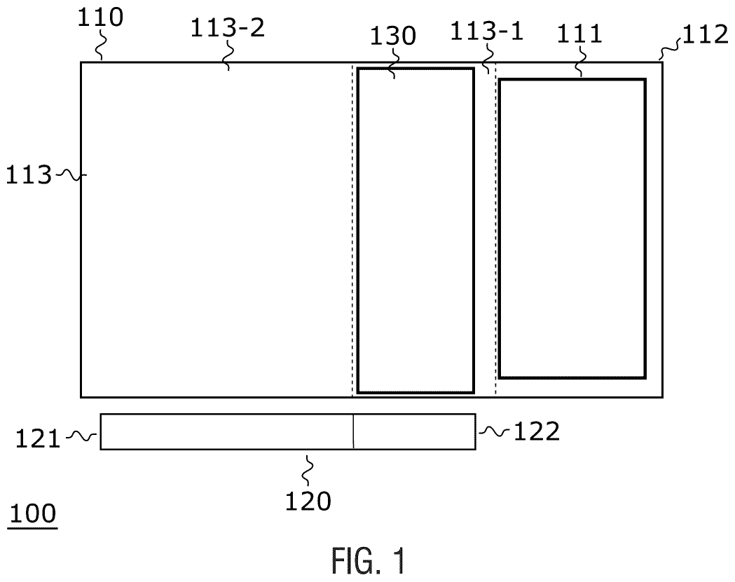

FIG. 1 schematically illustrates an acoustic system 100 comprising a speaker assembly 110 and an antenna assembly 120.

The speaker assembly 110 comprises a speaker driver 111. The speaker driver 111 is an active component configured to produce (output) sound. For example, the speaker driver 111 may be or comprise an electroacoustic transducer configured to convert electrical audio signals (e.g., received from a sound source such as signal line, a memory or a processor) into mechanical vibrations, i.e., sound. The speaker driver 111 may comprise various component such as one or more of a diaphragm, a voice coil, a magnet or a housing. The speaker driver 111 may be produced from various materials, in particular non-conductive (e.g., non-metallic) and conductive (e.g., metallic) materials. The speaker driver 111 may, e.g., be configured as a woofer for the reproduction of lower-frequency audio signals.

The speaker assembly 110 further comprises an enclosure 112. The enclosure 112 is a (physical) housing that comprises (encapsulates) the speaker driver 111. The enclosure 112 provides mechanical support and protects the speaker driver 111 from the environment. The enclosure 112 further provides (defines) a back volume 113 for the speaker driver 111. The back volume 113 is the enclosure 112's internal cavity located behind the speaker driver 111. The back volume 113 influences the acoustic properties of the speaker assembly 110, such as enhancing bass response and overall sound quality. For example, the enclosure 112 may be produced from plastic material such as Acrylonitrile Butadiene Styrene (ABS) or polycarbonate.

The antenna assembly 120 is for transmitting and/or receiving electromagnetic waves (signals). The antenna assembly 120 comprises an active region 121 and a ground region 122. The active region 121 is the electrically active portion of the antenna assembly. For example, the active region 121 may comprise conductive elements or traces configured to convert electrical signals into electromagnetic waves and vice versa. The active region 121 may exhibit a geometry and material properties adapted to meet target (desired) radiation characteristics (e.g., resonance characteristics and/or reception/transmission efficiencies) across one or more targeted frequency ranges. The ground region 122 provides a (e.g., low-impedance) path to ground and acts as a reference plane for the antenna assembly 120.

As indicated in FIG. 1, the antenna assembly 120 is disposed adjacent to the speaker assembly 110. In other words, the antenna assembly 120 is positioned (immediately) next to or (very) near the speaker assembly 110. The antenna assembly 120 is disposed (arranged) outside the enclosure 112.

The active region 121 of the antenna assembly 120 is disposed opposite a first portion 113-1 of the back volume 113. In other words, the active region 121 of the antenna assembly 120 is positioned so that it directly faces (only) the first portion 113-1 of the back volume 113. In still other words, an orthogonal projection of the active region 121 of the antenna assembly 120 onto the enclosure 112 overlaps with an orthogonal projection of the first portion 113-1 of the back volume 113 onto the enclosure 112.

The ground region 122 of the antenna assembly 120 is disposed opposite a second portion 113-2 of the back volume 113. In other words, the ground region 122 of the antenna assembly 120 is positioned so that it directly faces (only) the second portion 113-2 of the back volume 113. In still other words, an orthogonal projection of the ground region 122 of the antenna assembly 120 onto the enclosure 112 overlaps with an orthogonal projection of the second portion 113-2 of the back volume 113 onto the enclosure 112.

The orthogonal projection of the active region 121 of the antenna assembly 120 onto the enclosure 112 does not overlap with the orthogonal projection of the second portion 113-2 of the back volume 113 onto the enclosure 112. Analogously, the orthogonal projection of the ground region 122 of the antenna assembly 120 onto the enclosure 112 does not overlap with the orthogonal projection of the first portion 113-1 of the back volume 113 onto the enclosure 112.

The first and second portions 113-1 and 113-2 of the back volume 113 are separate sections (parts, subdivisions) of the speaker enclosure 112's internal cavity. The first and second portions 113-1 and 113-2 of the back volume 113 do not overlap.

A filler material 130 is disposed (arranged) within the back volume 113. The filler material 130 is configured to simulate a larger back volume for the speaker driver 111. In other words, the filler material 130 is configured to mimic the acoustic properties of a back volume larger than the back volume 113 without physically comprising (having) the same dimensions or composition. Due to this, the filler material 130 may also be referred as “virtual material” by those skilled in the art. By simulating a larger back volume for the speaker driver 111, the low-frequency response may be enhanced without physically enlarging the back volume 113 (i.e., the enclosure 112). For example, the filler material 130 may be configured to modify one or more acoustic characteristics such as the effective acoustic impedance or pressure distribution within at least part of the back volume 113 to simulate the larger back volume for the speaker driver 111. This results in enhanced low-frequency performance without increasing the physical size of the back volume 113 (i.e., the enclosure 112). The filler material may, e.g., be at least partially conductive to simulate the larger back volume for the speaker driver 111. At least partially conductive filler material allows to influence boundary conditions within the back volume 113, effectively reducing the acoustic stiffness. This means the speaker driver 111 “sees” a more compliant load, similar to that provided by a physically larger space. For example, the filler material 130 may be at least one of zeolite or activated carbon.

At least the first portion 113-1 of the back volume 113 is unoccupied by the filler material 130. In other words, the first portion 113-1 of the back volume 113 is left empty (unoccupied)—without any of the filler material 130 present.

By positioning the active region 121 opposite a section of the back volume 113 not filled with the filler material 130, potential interference between the filler material 130 and the antenna assembly 120 is minimized. The spatial separation helps maintain signal integrity and antenna performance. In particular, the arrangement of the active region 121 of the antenna assembly 120 opposite the unoccupied first portion 131-1 helps ensure that the active region 121 experiences reduced (e.g., minimal) interference from the filler material 130, thereby maintaining good (e.g., optimal) antenna performance. The acoustic system 100 efficiently utilizes the limited available space in compact devices by integrating speaker and antenna functions without mutual degradation.

The filler material 130 may at least partly occupy portions of the back volume 113 different from the first portion 113-1 of the back volume 113. In other words, aside from the first portion 113-1 of the back volume 113, the filler material 130 may be introduced into/be present in other areas of the speaker enclosure's back volume 113. The filler material 130 may fill these other regions partially or fully, e.g., based on design choices. This selective and partial occupation enables the acoustic system 100 to fine-tune both acoustic of the speaker assembly 110 and electromagnetic performance of the antenna assembly 120. As indicated in FIG. 1, the filler material 130 may particularly be disposed (arranged) in the second portion 113-2 of the back volume 113. In other words, the second portion 113-2 of the back volume 113 may at least partially be filed with the filler material 130 such that the filler material 130 may modify the acoustic characteristics of that portion without (significantly) affecting the active region 121 of the antenna assembly 120.

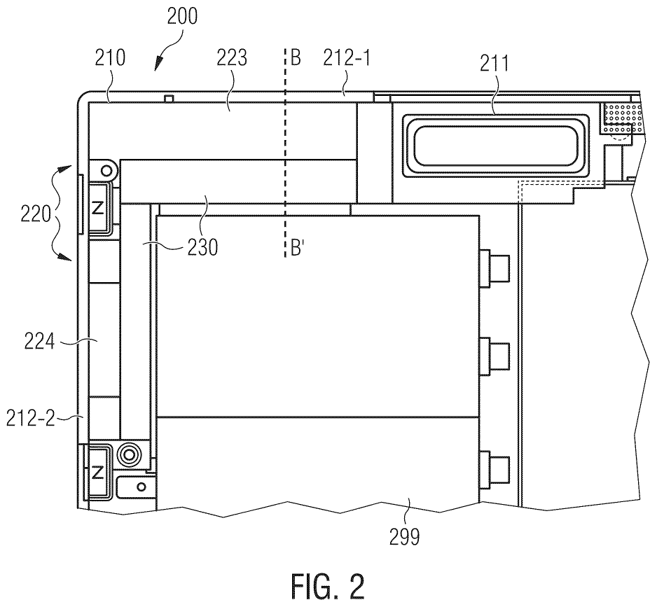

FIG. 2 schematically illustrates another acoustic system 200 in an assembly situation. In the example of FIG. 2, the acoustic system 200 is assembled in a mobile device 299 such as a laptop-computer or a tablet-computer. The acoustic system 200 is based on the acoustic system 100 described above.

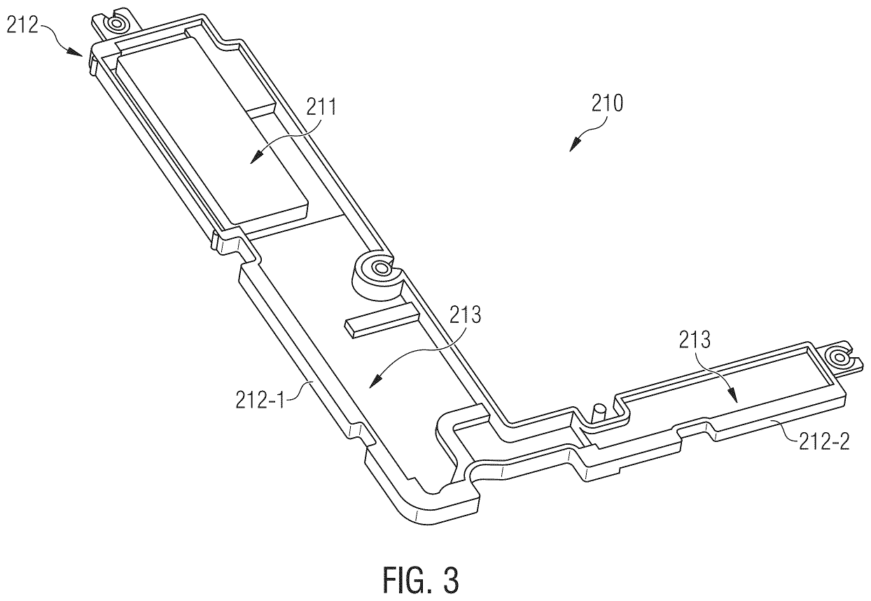

The acoustic system 200 comprises a speaker assembly 210, which is illustrated in greater detail in FIG. 3. The speaker assembly 210 comprises a speaker driver 211 and an enclosure 212. The enclosure 212 houses the speaker driver 211 (e.g., a woofer) and provides a back volume 213 for the speaker driver 211. The back volume 213 is a metal-free region of the speaker assembly 210 and, hence, allows for adjacent arrangement of antenna elements. The enclosure 212 is partially shown in FIG. 3 to illustrate the internal structure of the speaker assembly 210.

In the example of FIG. 2 and FIG. 3, the enclosure 212 comprises a first portion 212-1 and an adjoining second portion 212-2. The first portion 212-1 of the enclosure 212 extends along a first direction, and the second portion 212-2 of the enclosure 212 extends along a second direction different from the first direction. For example, the first and second directions may be orthogonal such that the first and second portions 212-1 and 212-2 may be orthogonal to each as illustrated in FIG. 2 and FIG. 3. The L-shaped enclosure 212 illustrated in FIG. 2 and FIG. 3 may allow to arrange the speaker assembly 210 in a corner portion of the mobile device 299. However, it should be noted that the angle between these two directions is not fixed to 90°—it may span any angle different from 90°. This means that the two adjoined portions 212-1 and 212-2 may in alternative examples be disposed (arranged) in various non-orthogonal configurations.

The acoustic system 200 further comprises an antenna assembly 220 disposed adjacent to the speaker assembly 210. In the example of FIG. 2, the antenna assembly 220 comprises a first antenna 223 and a second antenna 224 spaced apart from each other. Analogously to what is described above for the acoustic system 100, the first and second antennas 223 and 224 are disposed adjacent to a first portion of the back volume 213, which is unoccupied by filler material. The first antenna 223 is disposed (arranged) below the first portion 212-1 of the enclosure 212, and the second antenna 224 is disposed (arranged) below the second portion 212-2 of the enclosure 212 in the example of FIG. 2. For example, the first antenna 223 and the second antenna 224 may be tuned to different frequencies. This means that each antenna is optimized to operate at a distinct frequency band rather than both being configured for the same frequency. Tuning the antennas 223 and 224 to different frequencies enables the acoustic system 200 to handle multiple wireless standards or channels simultaneously, such as combining Wi-Fi, cellular, or Bluetooth functions.

The antennas 223 and 224 both comprise a respective active region and a respective ground region. Accordingly, the active region of the antenna assembly 210 comprises a first active sub-region for the first antenna 223 and a second active sub-region for the second antenna 224. The first active sub-region is disposed opposite a first sub-portion of the first portion of the back volume 213, and the second active sub-region is disposed opposite a second sub-portion of the first portion of the back volume 213. Similarly, the ground region of the antenna assembly 210 comprises a first ground sub-region for the first antenna 223 and a second ground sub-region for the second antenna 224. The first ground sub-region is disposed opposite a first sub-portion of a second portion of the back volume 213, and the second ground sub-region is disposed opposite a second sub-portion of the second portion of the back volume 213.

The first sub-portion of the second portion of the back volume 213 is located within the back volume 213 above the ground region of the first antenna 223. Analogously, the second sub-portion of the second portion of the back volume 213 is located within the back volume 213 above the ground region of the second antenna 224. Filler material 230, which is configured to simulate a larger back volume for the speaker driver 211, is disposed (arranged) in both sub-portions of the second portion of the back volume 213.

The first sub-portion of the first portion of the back volume 213 is located within the back volume 213 above the active region of the first antenna 223 and is unoccupied by the filler material 230. Analogously, the second sub-portion of the first portion of the back volume 213 is located within the back volume 213 above the active region of the second antenna 224 and is unoccupied by the filler material 230.

The filler material 230 is further disposed (arranged) in those parts of the back volume 213, which are not opposed to the first and second antennas 223 and 224. In other words, the portions of the back volume 213 different from the first and second sub-portions of the first portion of the back volume 213 are at least partially filled with the filler material 230.

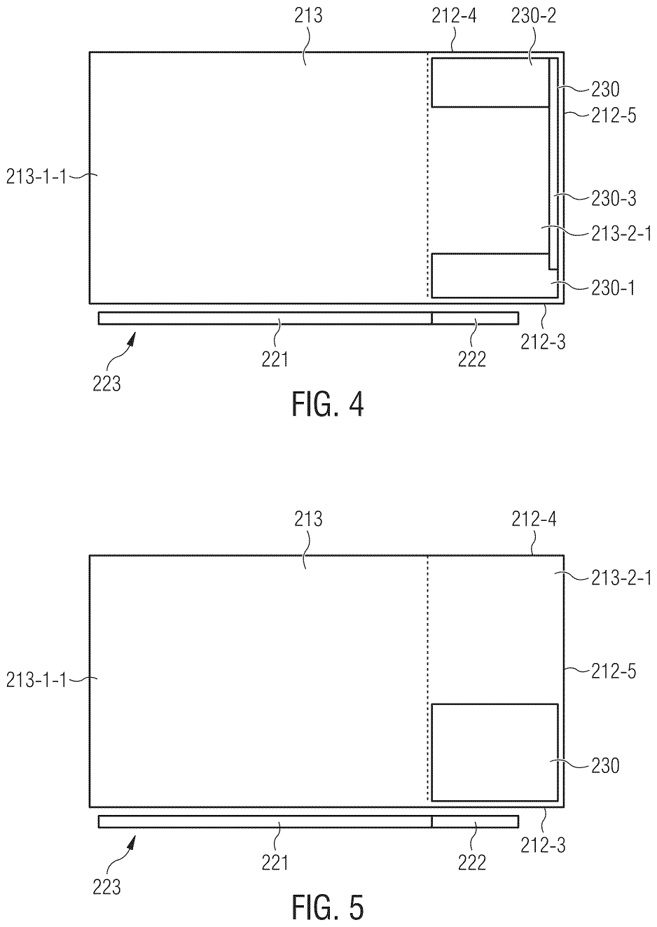

FIG. 4 illustrates a first exemplary arrangement of the filler material 230 within the back volume 213. FIG. 4 illustrates a cross-sectional view along the line B-B′ illustrated in FIG. 2.

The first antenna 223 is disposed (arranged) below the enclosure 212 and, hence, the back volume 213. The active region 221 of the first antenna 223 is disposed (arranged) below (opposite) the first sub-portion 213-1-1 of the first portion of the back volume 213. The ground region 222 of the first antenna 223 is disposed (arranged) below (opposite) the first sub-portion 213-2-1 of the second portion of the back volume 213. The first sub-portion 213-1-1 of the first portion of the back volume 213 is unoccupied by the filler material. The filler material 230 is disposed (arranged) in the first sub-portion 213-2-1 of the second portion of the back volume 213 and at least partly occupies portions of the back volume 213 different from the first and second sub-portions of the first portion of the back volume 213.

In the example of FIG. 3, the filler material 230 is disposed (arranged) within the back volume 213 in a configuration comprising a first portion 230-1, a second portion 230-2 and a third portion 230-3. The first portion 230-1 and the second portion 230-2 of the filler material 230 extend substantially parallel to each other along first and second sidewalls 212-3 and 212-4 of the enclosure 212. The first sidewall 212-3 is disposed (arranged) between the second sidewall 212-4 and the first antenna 223, i.e., the antenna assembly 220. The third portion 230-3 of the filler material 230 extends substantially perpendicular to the first and second portions 230-3 and 230-4 of the filler material 230 and connects them. The third portion 230-3 of the filler material 230 extends along a third sidewall 212-5 of the enclosure 212. Third sidewall 212-5 extends substantially perpendicular to the first and second sidewalls 212-3 and 212-4 and connects them. In other words, the first, second and third portions 230-1, 230-2 and 230-3 of the filler material 230 extend along respective sidewalls of the enclosure 212. The first portion 230-1 and the second portion 230-2 of the filler material 230 are spaced apart from each other by a distance equal to or greater than a sum of their respective thicknesses. The thickness of each portion of the filler material 230 refers to the dimension of each portion in a direction perpendicular to the respective sidewall of the housing 212 on which the respective portion of the filler material 230 is formed. In other words, the filler material 230 exhibits a C-shape in the exemplary arrangement of FIG. 4. This configuration (structure) allows to effectively modify acoustic characteristics of the back volume 213 to mimic a larger physical volume and thereby enhancing low-frequency performance without increasing the actual size of the enclosure 212. Furthermore, the amount of filling material 230 near the first antenna 223 may be kept low (minimal).

FIG. 5 illustrates an alternative second exemplary arrangement of the filler material 230 within the back volume 213. FIG. 5 illustrates a cross-sectional view along the line B-B′ illustrated in FIG. 3.

In the example of FIG. 5, the filler material 230 forms a continuous, solid volume extending along the first and third sidewalls 212-3 and 212-5 of the enclosure. The continuous, solid volume of the filler material 230 is spaced apart from the second sidewall 212-4. The continuous, solid volume of the filler material 230 extends along at least 20%, at least 25%, at least 30% or at least 35% of the third sidewall 212-5 (from the first sidewall 212-3 toward the second sidewall 212-4). The block-shaped configuration of the filler material 230 allows for precise tailoring of the back volume 213's effective volume.

The configurations of the filler material 230 shown in FIG. 4 and FIG. 5 with respect to the first antenna 223 may analogously be used for the portion of the enclosure 212 facing the second antenna 224 (i.e., the second active sub-region and the second ground sub-region of the back volume 213).

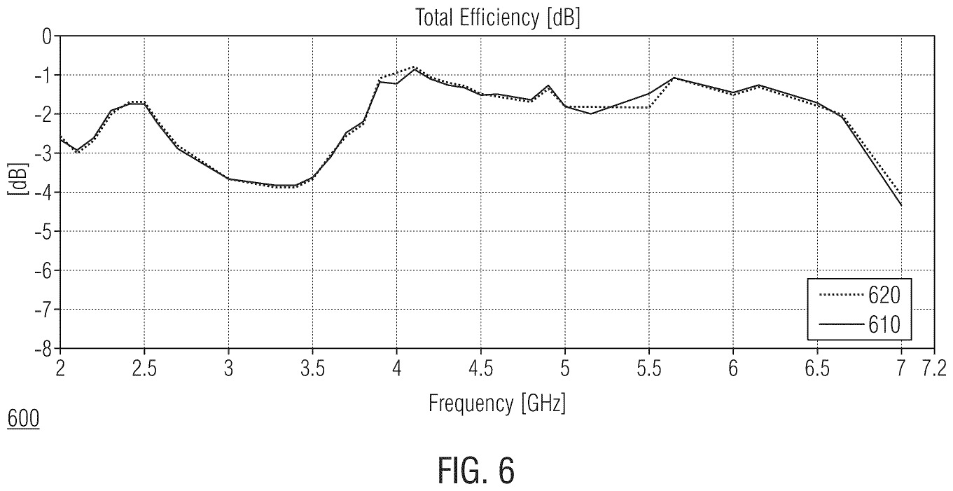

FIG. 6 further illustrates a diagram 600 showing comparison between the antenna performance of the antenna assembly 220 shown in FIG. 2 and a reference antenna assembly not filled with filler material. The abscissa of the diagram 600 denotes frequency in GHz, and the ordinate of the diagram 600 denotes the antenna performance in dB. Curve 610 represents the antenna performance of the antenna assembly 220 shown in FIG. 2. Curve 620 represents the antenna performance of the reference antenna assembly.

There is no significant deviation of the curve 610 from the curve 620. Hence, the impact of the filler material in the proposed arrangement is insignificant. The antenna performance is not degraded by the filler material in the proposed arrangement.

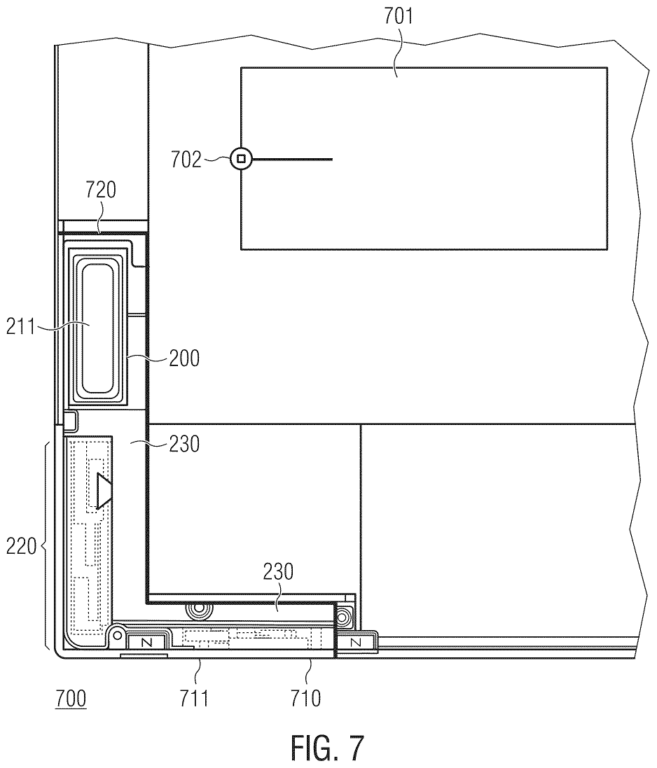

FIG. 7 illustrates a mobile device 700 such as a laptop-computer or a tablet-computer. The mobile device 700 comprises a casing 710. The casing defines a volume of the mobile device 700. The mobile device 700 further comprises an acoustic system as described herein. The acoustic system is disposed (arranged) within the volume of the mobile device 700. The acoustic system 200 as described above is shown for illustrative purposes in FIG. 7. However, it should be noted that any other configuration of the acoustic system described herein may be used instead. Accordingly, a mobile device with co-located speaker and antenna assemblies is provided, in which the speaker and antenna functions are integrated without mutual degradation.

In the example of FIG. 7, the acoustic system 200 is disposed (arranged) at a sidewall 711 of the casing 710. In particular, the acoustic system 200 is disposed (arranged) in a corner portion of the casing 710. The mobile device 700 further comprises a shielding structure 720 (e.g., a metal antenna barricade) attached to the casing 710 and extending along sides of the acoustic system 200 that do not face the sidewall 711 of the casing 710. The shielding structure 720 is provided to reduce electromagnetic coupling between the antenna assembly 220 and further components of the mobile device 700. The filler material 230 is disposed (arranged) between the shielding structure 720 and the first portion of the back volume of the speaker assembly's enclosure.

The further components of the mobile device 700 are potential noise sources for the antenna assembly 220. For example, the mobile device 700 may comprise further elements such as, e.g., an application processor, a baseband processor, memory, an audio driver, a camera driver, a touch screen, a display driver, sensors, removable memory, a power management integrated circuit or a smart battery. A Printed Circuit Board (PCB) 701 with a noise source 702 such as a microstrip trace is exemplarily shown in FIG. 7.

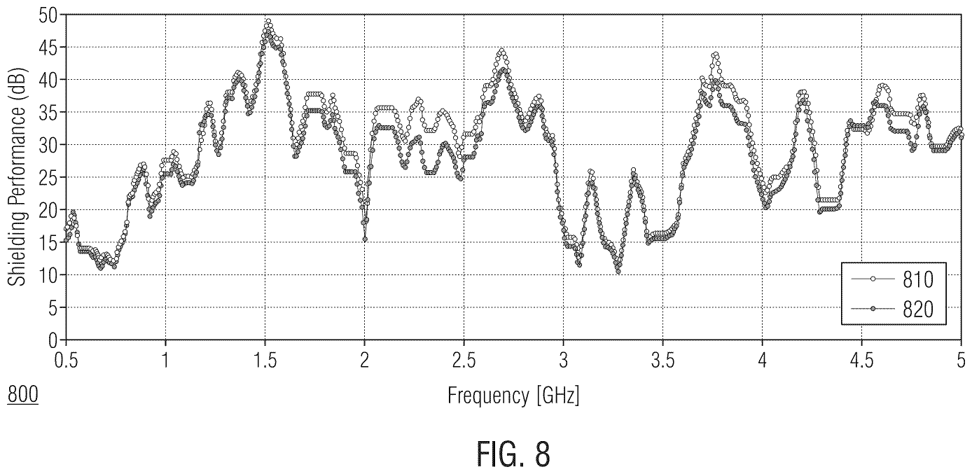

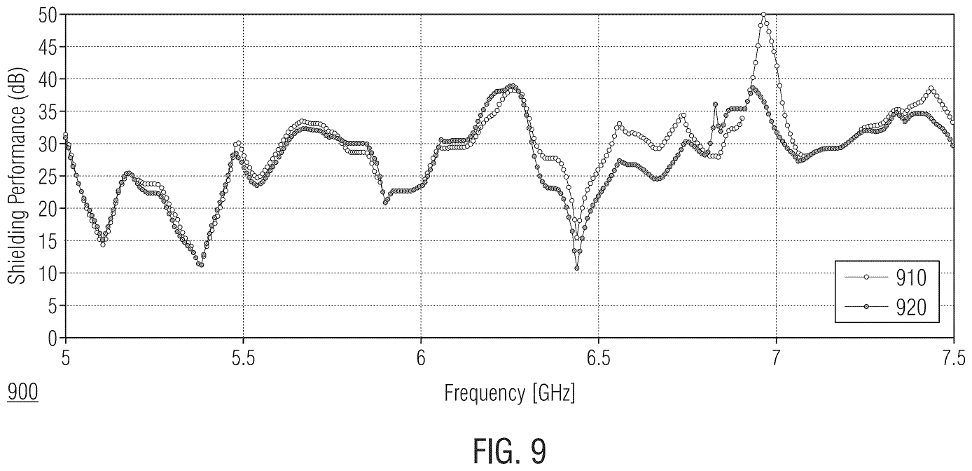

Diagrams 800 and 900 shown in FIG. 8 and FIG. 9 highlight the beneficial impact of the filler material on the shielding performance of the shielding structure 720. The diagrams 800 and 900 both show the shielding performance of the shielding structure 720. In both diagrams, the abscissa denotes frequency in GHz, and the ordinate denotes the shielding performance in dB. The diagram 800 shows the shielding performance for a first frequency range up to 5 GHZ, and the diagram shows the shielding performance for a second frequency range beyond 5 GHZ.

The curves 810 and 910 represent the shielding performance of the shielding structure 720. As a reference, curves 820 and 920 represent the shielding performance of the shielding 720 if the antenna assembly 220 was not filled with the filler material.

The shielding performance (shielding effectiveness) is calculated as follows:

$${S}_{p e r} = {I}_{RFI , w / o} - {I}_{RFI , w} \qquad ( 1 )$$

with Sₚₑᵣ denoting the shielding performance in dB, I_{RFI,w/o} denoting the RFI impact without the shielding structure 720 and I_{RFI,w} denoting the RFI impact with the shielding structure 720.

As can be seem from a comparison of the curves 810 and 910 to the curves 820 and 920, the proposed arrangement of the filler material causes neutral to 1.5 dB improvement at lower frequency below 1.5 GHz and causes significantly improved shielding performance for higher frequencies. On average, the proposed arrangement of the filler material causes a broadband reduction in RFI up to 3 dB. Due to its dielectric constant and conductivity property, the filler material helps in reflecting and storing the electromagnetic field resulting in a lower RFI. For example, the conductive nature of activated carbon material, which is an example for the filler material, may help in reducing the RFI noise coupling to the antenna assembly.

The filler material provides improved audio performance of the speaker assembly. Even though the filler material shows a conductive nature, the proposed arrangement near the antenna ground region allows to use the filler material without degrading the antenna performance. The electrical properties of the filler material even help in reducing the RFI (e.g., up to 3 dB). By increasing the level of impurities in e.g., activated carbon, which is an example for the filler material, the electrical properties of the filler material change, resulting in an even better RFI reduction.

Examples of the present disclosure provide a unique implementation of filler in a speaker box for co-location of speaker sub-systems with system antennas and enhanced wireless performance. Unlike in conventional designs, the proposed arrangement allows to enhance the speaker performance with any adverse impact on antenna performance and RFI. The proposed approach with filler material filled in a selected area of the speaker box in the unique fashion may offer negligible impact on antenna performance and in addition it may provide (e.g., up to 3 dB) reduction in RFI. Examples of the present disclosure may enable co-location of a filler material filled speaker sub-system and system antennas without compromising sub-system performance. The RFI reduction may be achieved by the unique way of implementing the filler material into the speaker box. In a thin and light system such as a premium laptop, the co-location is a desired feature.

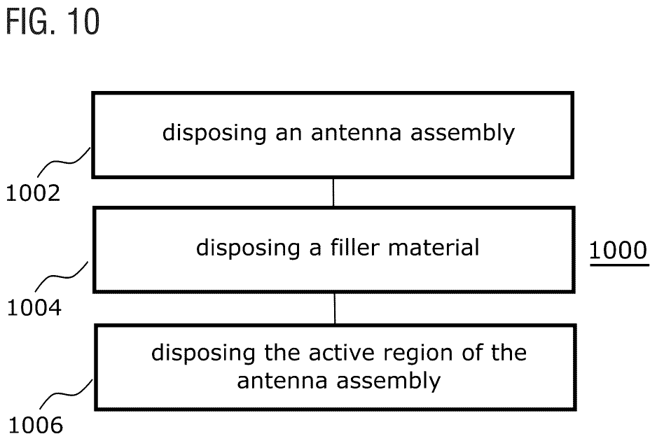

FIG. 10 further illustrates a flowchart of a method 1000 of manufacturing an acoustic system as described herein. The method 1000 comprises disposing (arranging) 1002 an antenna assembly adjacent to a speaker assembly. The speaker assembly comprises a speaker driver and an enclosure defining a back volume for the speaker driver. The antenna assembly comprises an active region and a ground region. Additionally, the method 1000 comprises disposing (arranging) 1004 a filler material within the back volume and configuring it to simulate a larger back volume for the speaker driver. Further, the method 1000 comprises disposing (arranging) 1006 the active region of the antenna assembly opposite a first portion of the back volume. The first portion of the back volume is unoccupied by the filler material.

The method 1000 allows to manufacture an acoustic system as described herein.

More details and aspects of the method 1000 are explained in connection with the proposed technique or one or more examples described above (e.g., FIG. 1 to FIG. 9). The method 1000 may comprise one or more additional optional features corresponding to one or more aspects of the proposed technique or one or more examples described above. For example, the method 1000 may further comprise disposing the ground region of the antenna assembly opposite a second portion of the back volume, wherein the filler material is disposed in the second portion of the back volume.

The examples described herein may be summarized as follows:

An example (e.g., example 1) relates to an acoustic system. The acoustic system comprises a speaker assembly including a speaker driver and an enclosure defining a back volume for the speaker driver. The acoustic system additionally comprises an antenna assembly disposed adjacent to the speaker assembly. The antenna assembly comprises an active region and a ground region. Further, the acoustic system comprises a filler material disposed within the back volume and configured to simulate a larger back volume for the speaker driver. The active region of the antenna assembly is disposed opposite a first portion of the back volume. The first portion of the back volume is unoccupied by the filler material.

Another example (e.g., example 2) relates to a previous example (e.g., example 1) or to any other example, wherein the ground region of the antenna assembly is disposed opposite a second portion of the back volume, and wherein the filler material is disposed in the second portion of the back volume.

Another example (e.g., example 3) relates to a previous example (e.g., one of the examples 1 or 2) or to any other example, wherein the filler material is disposed within the back volume in a configuration comprising a first portion, a second portion and a third portion, wherein the first portion and the second portion of the filler material extend substantially parallel to each other, and wherein the third portion of the filler material extends substantially perpendicular to the first and second portions of the filler material and connects them.

Another example (e.g., example 4) relates to a previous example (e.g., example 3) or to any other example, wherein the first, second and third portions of the filler material extend along respective sidewalls of the enclosure.

Another example (e.g., example 5) relates to a previous example (e.g., example 3 or example 4) or to any other example, wherein the first portion and the second portion of the filler material are spaced apart from each other by a distance equal to or greater than a sum of their respective thicknesses.

Another example (e.g., example 6) relates to a previous example (e.g., one of the examples 1 or 2) or to any other example, wherein the enclosure comprises a first sidewall, a second sidewall, and a third sidewall, wherein the first and second sidewalls extend substantially parallel to each other, wherein the third sidewall extends substantially perpendicular to the first and second sidewalls and connects them, and wherein the filler material forms a continuous, solid volume extending along the first and third sidewalls.

Another example (e.g., example 7) relates to a previous example (e.g., example 6) or to any other example, wherein the continuous, solid volume of the filler material is spaced apart from the second sidewall.

Another example (e.g., example 8) relates to a previous example (e.g., one of the examples 6 or 7) or to any other example, wherein the first sidewall is disposed between the second sidewall and the antenna assembly.

Another example (e.g., example 9) relates to a previous example (e.g., one of the examples 6 to 8) or to any other example, wherein the continuous, solid volume of the filler material extends along at least 25% of the third sidewall.

Another example (e.g., example 10) relates to a previous example (e.g., one of the examples 1 to 9) or to any other example, wherein the antenna assembly comprises a first antenna and a second antenna spaced apart from each other, wherein the active region of the antenna assembly comprises a first active sub-region for the first antenna and a second active sub-region for the second antenna, wherein the first active sub-region is disposed opposite a first sub-portion of the first portion of the back volume, and wherein the second active sub-region is disposed opposite a second sub-portion of the first portion of the back volume.

Another example (e.g., example 11) relates to a previous example (e.g., example 10) or to any other example, wherein the first antenna and the second antenna are tuned to different frequencies.

Another example (e.g., example 12) relates to a previous example (e.g., one of the examples 1 to 11) or to any other example, wherein the enclosure comprises a first portion and an adjoining second portion, wherein the first portion of the enclosure extends along a first direction, and wherein the second portion of the enclosure extends along a second direction different from the first direction.

Another example (e.g., example 13) relates to a previous example (e.g., one of the examples 1 to 12) or to any other example, wherein an orthogonal projection of the active region of the antenna assembly onto the enclosure overlaps with an orthogonal projection of the first portion of the back volume onto the enclosure.

Another example (e.g., example 14) relates to a previous example (e.g., one of the examples 1 to 13) or to any other example, wherein an orthogonal projection of the ground region of the antenna assembly onto the enclosure overlaps with an orthogonal projection of the second portion of the back volume onto the enclosure.

Another example (e.g., example 15) relates to a previous example (e.g., one of the examples 1 to 14) or to any other example, wherein the filler material is at least partially conductive to simulate the larger back volume for the speaker driver.

Another example (e.g., example 16) relates to a previous example (e.g., one of the examples 1 to 15) or to any other example, wherein the filler material at least partly occupies portions of the back volume different from the first portion of the back volume.

An example (e.g., example 17) relates to a mobile device comprising a casing defining a volume of the mobile device, and an acoustic system according to a previous example (e.g., one of the examples 1 to 16) or to any other example disposed within the volume of the mobile device.

Another example (e.g., example 18) relates to a previous example (e.g., example 17) or to any other example, wherein the acoustic system is disposed at a sidewall of the casing, and wherein the mobile device further comprises a shielding structure attached to the casing and extending along sides of the acoustic system that do not face the sidewall of the casing to reduce electromagnetic coupling between the antenna assembly and further components of the mobile device.

Another example (e.g., example 19) relates to a previous example (e.g., example 18) or to any other example, wherein the filler material is disposed between the shielding structure and the first portion of the back volume.

Another example (e.g., example 20) relates to a previous example (e.g., one of the examples 17 to 19) or to any other example, wherein the mobile device is a laptop-computer or a tablet-computer.

An example (e.g., example 21) relates to a method of manufacturing an acoustic system. The method comprises disposing an antenna assembly adjacent to a speaker assembly. The speaker assembly comprises a speaker driver and an enclosure defining a back volume for the speaker driver. The antenna assembly comprises an active region and a ground region. Additionally, the method comprises disposing a filler material within the back volume and configuring it to simulate a larger back volume for the speaker driver. Further, the method comprises disposing the active region of the antenna assembly opposite a first portion of the back volume. The first portion of the back volume is unoccupied by the filler material.

Another example (e.g., example 22) relates to a previous example (e.g., example 22) or to any other example, wherein the method further comprises disposing the ground region of the antenna assembly opposite a second portion of the back volume, and wherein the filler material is disposed in the second portion of the back volume.

The aspects and features described in relation to a particular one of the previous examples may also be combined with one or more of the further examples to replace an identical or similar feature of that further example or to additionally introduce the features into the further example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A system comprising:
a speaker assembly comprising a speaker driver and an enclosure defining a back volume for the speaker driver;
an antenna assembly disposed adjacent to the speaker assembly, the antenna assembly comprising an active region and a ground region; and
a filler material disposed within the back volume and configured to simulate a larger back volume for the speaker driver,
wherein the active region of the antenna assembly is disposed opposite a first portion of the back volume, and wherein the first portion of the back volume is unoccupied by the filler material.

2. The system of claim 1, wherein the ground region of the antenna assembly is disposed opposite a second portion of the back volume, and wherein the filler material is disposed in the second portion of the back volume.

3. The system of claim 1, wherein the filler material is disposed within the back volume in a configuration comprising a first portion, a second portion and a third portion, wherein the first portion and the second portion of the filler material extend substantially parallel to each other, and wherein the third portion of the filler material extends substantially perpendicular to the first and second portions of the filler material and connects them.

4. The system of claim 3, wherein the first, second and third portions of the filler material extend along respective sidewalls of the enclosure.

5. The system of claim 3, wherein the first portion and the second portion of the filler material are spaced apart from each other by a distance equal to or greater than a sum of their respective thicknesses.

6. The system of claim 1, wherein the enclosure comprises a first sidewall, a second sidewall, and a third sidewall, wherein the first and second sidewalls extend substantially parallel to each other, wherein the third sidewall extends substantially perpendicular to the first and second sidewalls and connects them, and wherein the filler material forms a continuous, solid volume extending along the first and third sidewalls.

7. The system of claim 6, wherein the continuous, solid volume of the filler material is spaced apart from the second sidewall.

8. The system of claim 6, wherein the first sidewall is disposed between the second sidewall and the antenna assembly.

9. The system of claim 6, wherein the continuous, solid volume of the filler material extends along at least 25% of the third sidewall.

10. The system of claim 1, wherein the antenna assembly comprises a first antenna and a second antenna spaced apart from each other, wherein the active region of the antenna assembly comprises a first active sub-region for the first antenna and a second active sub-region for the second antenna, wherein the first active sub-region is disposed opposite a first sub-portion of the first portion of the back volume, and wherein the second active sub-region is disposed opposite a second sub-portion of the first portion of the back volume.

11. The system of claim 10, wherein the first antenna and the second antenna are tuned to different frequencies.

12. The system of claim 1, wherein the enclosure comprises a first portion and an adjoining second portion, wherein the first portion of the enclosure extends along a first direction, and wherein the second portion of the enclosure extends along a second direction different from the first direction.

13. The system of claim 1, wherein an orthogonal projection of the active region of the antenna assembly onto the enclosure overlaps with an orthogonal projection of the first portion of the back volume onto the enclosure.

14. The system of claim 1, wherein an orthogonal projection of the ground region of the antenna assembly onto the enclosure overlaps with an orthogonal projection of the second portion of the back volume onto the enclosure.

15. The system of claim 1, wherein the filler material is at least partially conductive to simulate the larger back volume for the speaker driver.

16. The system of claim 1, wherein the filler material at least partly occupies portions of the back volume different from the first portion of the back volume.

17. A mobile device comprising:
a casing defining a volume of the mobile device; and
a system disposed within the volume of the mobile device, the system comprising:
a speaker assembly comprising a speaker driver and an enclosure defining a back volume for the speaker driver;
an antenna assembly disposed adjacent to the speaker assembly, the antenna assembly comprising an active region and a ground region; and
a filler material disposed within the back volume and configured to simulate a larger back volume for the speaker driver,
wherein the active region of the antenna assembly is disposed opposite a first portion of the back volume, and wherein the first portion of the back volume is unoccupied by the filler material.

18. The mobile device of claim 17, wherein the system is disposed at a sidewall of the casing, and wherein the mobile device further comprises a shielding structure attached to the casing and extending along sides of the system that do not face the sidewall of the casing to reduce electromagnetic coupling between the antenna assembly and further components of the mobile device.

19. The mobile device of claim 18, wherein the filler material is disposed between the shielding structure and the first portion of the back volume.

20. A method comprising:
disposing an antenna assembly adjacent to a speaker assembly, wherein speaker assembly comprises a speaker driver and an enclosure defining a back volume for the speaker driver, and wherein the antenna assembly comprises an active region and a ground region;
disposing a filler material within the back volume and configuring it to simulate a larger back volume for the speaker driver; and
disposing the active region of the antenna assembly opposite a first portion of the back volume, wherein the first portion of the back volume is unoccupied by the filler material.
